(19) United States
(12) Patent Application Publication
(10) Pub. No.: US 2009/0102724 A1
(43) Pub. Date: Apr. 23, 2009

(54) CIRCULAR POLARIZED ANTENNA, SEMICONDUCTOR MODULE, AND WIRELESS COMMUNICATION DEVICE

(75) Inventor: Yukako TSUTSUMI, Yokohama-shi (JP)

Correspondence Address: KIMBLE INTELLECTUAL PROPERTY LAW, PLLC, 1701 PENNSYLVANIA AVE., NW, SUITE 300, WASHINGTON, DC, 20006, US

(73) Assignee: Kabushiki Kaisha Toshiba, Tokyo (JP)

(21) Appl. No.: 12/165,936

(22) Filed: Jul. 1, 2008

(30) Foreign Application Priority Data
Oct. 19, 2007 (JP) 2007-273100

(51) Int. Cl. H01Q 1/38

(52) U.S. Cl. 343/700 MS

(57) ABSTRACT

A circular polarized antenna includes: a conductor ground plate; first and second monopole conductor elements; and a feed point provided at one of first and second connection points, wherein a first and second parts of the antenna are configured to be symmetrical with respect to a straight line passing between open ends of the first and second monopole conductor elements, wherein the first part includes: (1) a first half of the conductor ground plate formed on one side of the straight line including the first monopole conductor element; and (2) the first monopole conductor element, and wherein the second part includes: (3) a second half of the conductor ground plate formed on the other side of the straight line including the second monopole conductor element; and (4) the second monopole conductor element.

### RELATED APPLICATION(S)

The present disclosure relates to the subject matters contained in Japanese Patent Application No. 2007-273100 filed on Oct. 19, 2007, which are incorporated herein by reference in its entirety.

### FIELD

The present invention relates to a circular polarized antenna, a semiconductor module, and a wireless communication device provided with the circular polarized antenna.

### BACKGROUND

In an RFID system, the use of a circular polarized antenna as a reader/writer antenna is required in order to communicate regardless of the direction of an IC tag. In a millimeter wave wireless communication system, in order to reduce the effect caused by a delayed wave in a multipath environment, the use a circular polarized antenna is required. In these systems, small and simple-shaped antennas are desired. However, a conventional circular polarized antenna involves two feed points, causing the antenna to be configured complicated and large in size.

Accordingly, there is proposed a simplified configuration for a circular polarized antenna by reducing the number of the feed point to one. An example of such configuration is disclosed in JP-A-2005-236656.

In the circular polarized antenna disclosed in JP-A-2005-236656, power is supplied to a linear element that is arranged perpendicularly to a monopole antenna through a power transfer part in the monopole antenna. According to this configuration, not only the monopole antenna but also the linear element becomes radiation source, enabling to radiate circular polarized wave despite an antenna with single feed point.

In the RFID system and the millimeter wave wireless communication system, it is required to perform favorable communications in a frequency band of a wide range. For example, for the RFID system, a frequency band of 860 MHz to 960 MHz (fractional bandwidth of 11% or more) is internationally standardized. In the millimeter waveband wireless communication system, a frequency band near 7 GHz (fractional bandwidth about 11%) can be used with no license in countries such as Japan, Europe, and United States. The fractional bandwidth is an index indicating the ratio of the bandwidth to the central operating frequency and is calculated as follows.

fractional bandwidth=bandwidth/central oparating frequency (1)

In the description herein, the fractional bandwidth of the circular polarized antenna refers to the fractional bandwidth in the impedance characteristics or the axial ratio characteristics. It can be said that the circular polarized antenna having large fractional bandwidth can perform favorable communications in a frequency band of a wide range.

However, in the circular polarized antenna disclosed in JP-A-2005-236656, the fractional bandwidth is not considered at all. In the circular polarized antenna disclosed in JP-A-2005-236656, the linear element requires the length of a half wavelength or more and the element length of a monopole antenna is a quarter wavelength. Since the monopole antenna and the linear element differ in the element length these also differ in current intensity. This causes the reduction in the fractional bandwidth in the axial ratio characteristics.

### SUMMARY

According to a first aspect of the invention, there is provided a circular polarized antenna including: a conductor ground plate that is formed with an opening; first and second monopole conductor elements that are formed in L-shape having substantially the same length, the first and second monopole conductor elements being respectively connected to the conductor ground plate at first and second connection points; and a feed point provided at one of the first and second connection points, wherein the first and second monopole conductor elements are arranged to be substantially orthogonal to each other, and open ends of the respective first and second monopole conductor elements are arranged to be adjacent to each other, wherein a first part and a second part of the antenna are configured to be symmetrical with respect to a straight line passing between the open ends of the first and second monopole conductor elements, the straight line being substantially perpendicular to a line connecting the first and second connection points, wherein the first part includes: (1) a first half of the conductor ground plate formed on one side of the straight line including the first monopole conductor element; and (2) the first monopole conductor element, and wherein the second part includes: (3) a second half of the conductor ground plate formed on the other side of the straight line including the second monopole conductor element; and (4) the second monopole conductor element.

According to a second aspect of the invention, there is provided a semiconductor module including: a dielectric substrate; and the antenna according to the first aspect being placed on the dielectric substrate.

According to a third aspect of the invention, there is provided a wireless communication device including: the antenna according to the first aspect; and a wireless circuit that is placed on the conductor ground plate of the antenna.

### BRIEF DESCRIPTION OF THE DRAWINGS

In the accompanying drawings:

FIG. 1 is a drawing to show a configuration of a circular polarized antenna according to a first embodiment of the present invention;

FIGS. 2A and 2B are drawings to show the operation of the circular polarized antenna;

FIG. 3 is a drawing to show the operation of the circular polarized antenna;

FIG. 4 is a drawing to show a simulation result of the circular polarized antenna;

FIG. 5 is a drawing to show a simulation result of the circular polarized antenna;

FIG. 6 is a drawing to show a simulation result of the circular polarized antenna;

FIG. 7 is a drawing to show a modified example of the circular polarized antenna;

FIG. 8 is a drawing to show a modified example of the circular polarized antenna;

FIG. 9 is a drawing to show another modified example of the circular polarized antenna;

FIG. 10 is a drawing to show a configuration of a circular polarized antenna according to a second embodiment of the present invention;

FIG. 11 is a drawing to show a modified example of the circular polarized antenna according to the second embodiment;

FIG. 12 is a drawing to show a configuration of a circular polarized antenna according to a third embodiment of the present invention;

FIG. 13 is a drawing to show a simulation result of the circular polarized antenna according to the third embodiment;

FIG. 14 is a drawing to show a simulation result of the circular polarized antenna according to the third embodiment;

FIG. 15 is a drawing to show a simulation result of the circular polarized antenna according to the third embodiment;

FIG. 16 is a drawing to show a configuration of a semiconductor module according to a fourth embodiment of the present invention;

FIG. 17 is a drawing to show a configuration of a wireless communication device according to a fifth embodiment of the present invention;

FIG. 18 is a drawing to show a configuration of a wireless system according to a sixth embodiment of the present invention; and

FIG. 19 is a drawing to show a configuration of an RFID system according to a seventh embodiment of the present invention.

### DETAILED DESCRIPTION OF THE EMBODIMENTS

Referring now to the accompanying drawings, embodiments of the present invention are described.

### First Embodiment

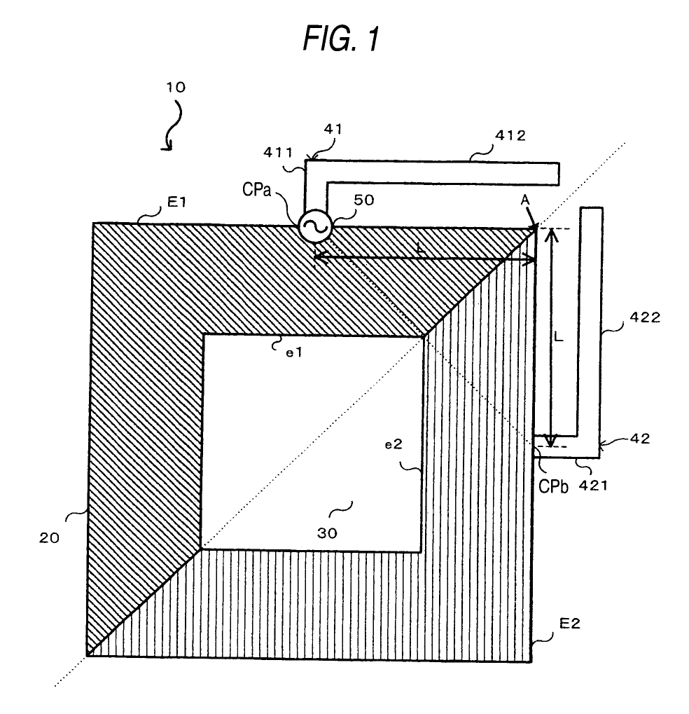

A circular polarized antenna according to a first embodiment of the present invention will be described with reference to FIGS. 1 to 9. FIG. 1 is a drawing to show a configuration of a circular polarized antenna 10 according to the first embodiment.

The circular polarized antenna 10 includes a conductor ground plate 20 having a cutout (hole) 30, L-shaped monopole conductor elements 41 and 42 connected to the conductor ground plate 20 at connection points CPa and CPb, and a feed point 50 provided in the connection point CPa of the conductor ground plate 20 and the L-shaped monopole conductor element 41.

The conductor ground plate 20 is a thin plate formed of metal having high electrical conductivity, such as copper, aluminum, sliver, and gold. The thickness of the conductor ground plate 20 is sufficiently thin with respect to central operating frequency of the circular polarized antenna and may be about one-50th wavelength to one-100th wavelength. The conductor ground plate 20 is square shaped and in the center the cutout 30 having square shaped is formed.

The L-shaped monopole conductor elements 41 and 42 are linear elements formed of metal having high electrical conductivity like the conductor ground plate 20.

The L-shaped monopole conductor element 41 has linear elements 411 and 412. The linear element 411 is connected at one end to an edge E1 of the conductor ground plate 20 through the feed point 50 at the connection point CPa at a position at a distance L from an apex A of the conductor ground plate 20. The linear element 411 is placed perpendicularly to the edge E1. The linear element 412 is connected at one end to an opposite end of the linear element 411 and is placed so as to be parallel with the edge E1.

The L-shaped monopole conductor element 42 has linear elements 421 and 422. The linear element 421 is connected at one end to an edge E2 of the conductor ground plate 20 at the connection point CPb at a position at a distance L from the apex A of the conductor ground plate 20. The linear element 421 is placed perpendicularly to the edge E2. The linear element 422 is connected at one end to an opposite end of the linear element 421 and is placed so as to be parallel with the edge E2.

The linear elements 412 and 422 are arranged so that the opposite ends (open ends) are arranged to be adjacent to each other in the vicinity of the apex A of the conductor ground plate 20. That is, the L-shaped monopole conductor elements 41 and 42 are formed so as to be symmetrical with respect to a line passing through the apex A and roughly perpendicular to the line connecting the connection points CPa and CPb (which will be hereinafter referred to as symmetry axis).

A first conductor ground plate portion of the conductor ground plate 20 (hatched portion in FIG. 1) formed on the side of the L-shaped monopole conductor element 41 from the symmetry axis and a second conductor ground plate portion of the conductor ground plate 20 (vertical line portion in FIG. 1) formed on the side of the L-shaped monopole conductor element 42 from the symmetry axis are roughly symmetrical with respect to the symmetry axis. That is, the symmetry axis is a diagonal line of the conductor ground plate 20 and the antenna according to the embodiment is of symmetrical shape with respect to the symmetry axis.

The expression “the opposite ends (open ends) are arranged to be adjacent to each other” is used to mean that the distance between the open ends is equal to or less than about one-25th wavelength of the resonance frequency. However, the distance between the open ends is adjusted, whereby the impedance characteristics can be adjusted. Therefore, the distance between the open ends is not limited to the one-25th wavelength.

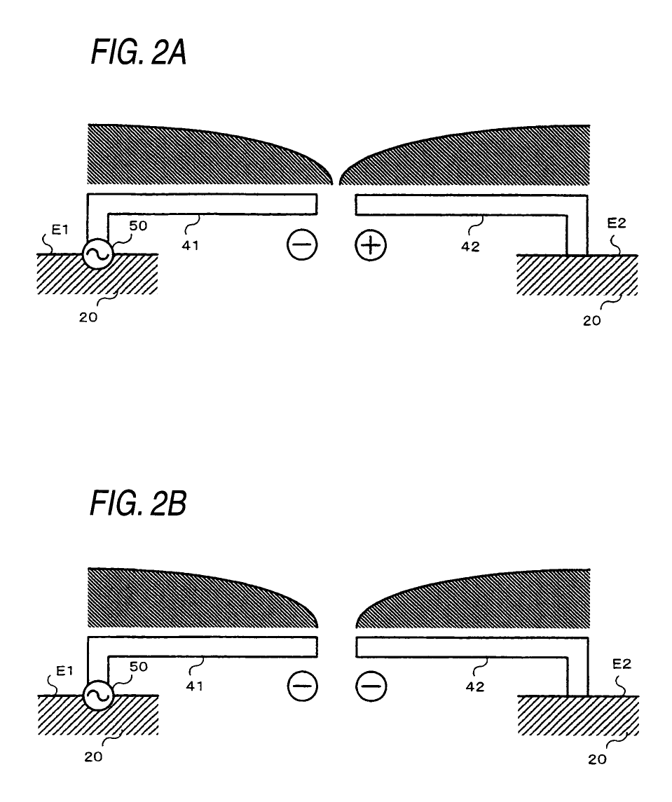

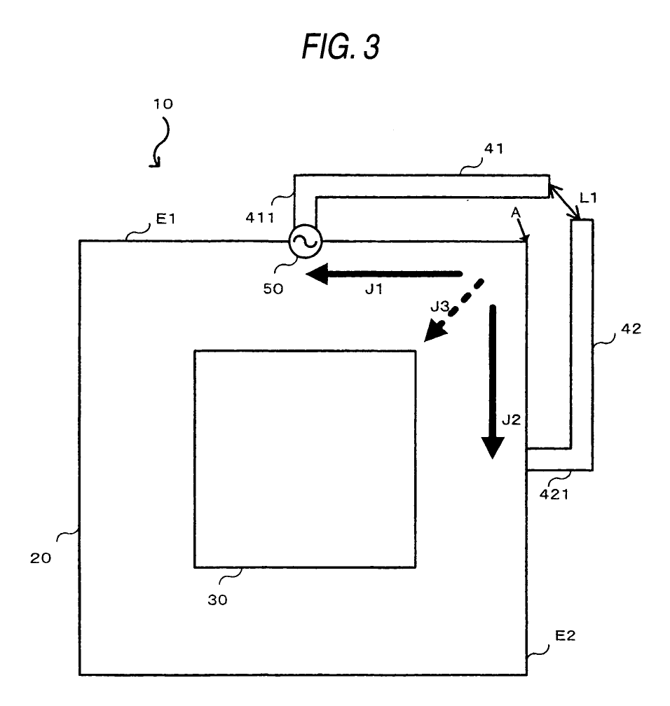

Next, the operation principle of the circular polarized antenna 10 according to the embodiment will be described with FIGS. 2 and 3. Here, the operation principle will be described about transmission of a wireless signal, but similar comments also apply to reception of a wireless signal.

First Operation State

FIG. 2A is a drawing to show an example of a first operation state of the circular polarized antenna 10. If a low-frequency wireless signal is supplied to the L-shaped monopole conductor element 41 through the feed point 50, opposite-sign charges occur much at the open ends of the L-shaped monopole conductor elements 41 and 42. In the example in FIG. 2A, negative charge occurs at the open end of the L-shaped monopole conductor element 41 and positive charge occurs at the open end of the L-shaped monopole conductor element 42.

At this time, stray capacitance occurs between the open ends of the L-shaped monopole conductor elements 41 and 42. The collective electric element length of the L-shaped monopole conductor elements 41 and 42 becomes as it is seen long because of the effect of the stray capacitance. Therefore, the L-shaped monopole conductor elements 41 and 42 resonate in the low-frequency and the wireless signal is transmitted. Here, the lowest frequency at which the L-shaped monopole conductor elements 41 and 42 resonate is referred to as the lowest resonance frequency.

Second Operation State

FIG. 2B is a drawing to show an example of a second operation state of the circular polarized antenna 10. To transmit a high-frequency wireless signal, if the wireless signal is supplied through the feed point 50, same-sign charges occur much at the open ends of the L-shaped monopole conductor elements 41 and 42. In the example in FIG. 2B, negative charge occurs at the open ends of the L-shaped monopole conductor elements 41 and 42.

At this time, stray capacitance occurring between the open ends of the L-shaped monopole conductor elements 41 and 42 has a capacitance value lessened. Therefore, it becomes hard to receive the effect of the stray capacitance and thus the electric element length of the L-shaped monopole conductor elements 41 and 42 becomes close to the element length of the L-shaped monopole conductor elements 41 and 42 and the L-shaped monopole conductor elements 41 and 42 resonate at a high frequency as compared with the first operation state. At this time, opposite-phase currents flow into the L-shaped monopole conductor elements 41 and 42. That is, the phase difference between the currents flowing into the L-shaped monopole conductor elements 41 and 42 becomes almost 180 degrees. Here, the highest frequency at which the L-shaped monopole conductor elements 41 and 42 resonate is referred to as the highest resonance frequency. If the frequency is simply called the resonance frequency, it means the highest resonance frequency.

Third Operation State

The case where a wireless signal is transmitted at any desired frequency in a frequency band between the highest resonance frequency and the lowest resonance frequency (which will be hereinafter referred to as intermediate frequency) will be described. If an intermediate-frequency wireless signal is supplied through the feed point 50 to the L-shaped monopole conductor element 41, charge occurs at the open ends of the L-shaped monopole conductor elements 41 and 42. Stray capacitance occurring between the open ends becomes a capacitance value such that the electric element length of each of the L-shaped monopole conductor elements 41 and 42 becomes a length as much as a quarter wavelength of the intermediate frequency. Therefore, the L-shaped monopole conductor elements 41 and 42 resonate at the intermediate frequency and transmit the wireless signal.

As described above, the circular polarized antenna 10 according to the embodiment resonates at a wide frequency in the range of the lowest resonance frequency to the highest resonance frequency as it enters any state of the first to third operation states. Accordingly, the fractional bandwidth of the circular polarized antenna 10 in the impedance characteristics is improved. The stray capacitance value between the open ends also varies depending on the distance between the open ends of the L-shaped monopole conductor elements 41 and 42. Therefore, if the distance between the open ends changes, the lowest resonance frequency of the circular polarized antenna 10 also changes. Consequently, the impedance characteristics of the circular polarized antenna 10 can be adjusted by adjusting the distance between the open ends.

Subsequently, improvement of the fractional bandwidth in the axial ratio characteristics of the circular polarized antenna 10 will be described with FIG. 3. To begin with, two orthogonal currents flow into the antenna and if the currents are the same in magnitude and have a phase difference of 90 degrees, a circular polarized wave having good axial ratio characteristics (circular polarized wave close to a circle) is radiated.

The main radiation source of the circular polarized antenna 10 is the portions perpendicular to the edges E1 and E2 of the L-shaped monopole conductor elements 41 and 42 (linear elements 411 and 412); currents J1 and J2 induced and produced in the L-shaped monopole conductor elements 41 and 42 also flow into the conductor ground plate 20. The orthogonal currents J1 and J2 flow into the conductor ground plate 20 and merge in the vicinity of the apex A and a current J3 flowing in a slanting direction relative to the edges E1 and E2 occurs.

The current J3 flowing in the slanting direction relative to the edges E1 and E2 does not intersect the current J1 or J2 at right angles and hinders occurrence of a circular polarized wave. However, the circular polarized antenna 10 has the conductor ground plate 20 formed with the cutout 30. The cutout 30 makes the current J3 hard to flow. Occurrence of the current J3 is suppressed, so that a good circular polarized wave is radiated from the circular polarized antenna 10.

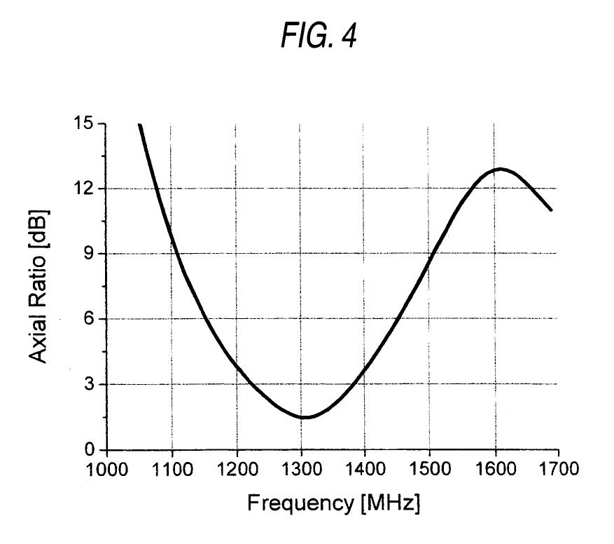

The result of simulation using the circular polarized antenna 10 will be described with FIGS. 4 to 6. A configuration of the circular polarized antenna 10 used for the simulation is as follows.

The conductor ground plate 20 is formed in square shape measuring 80 mm per side as the outline and has the cutout 30 in the center. The L-shaped monopole conductor element 41, 42 has the vertical portion (linear element 411, 421) being 10 mm long and the horizontal portion (linear element 412, 422) being 46 mm long, and the whole element length is 56 mm. The line distance between the open ends of the L-shaped monopole conductor elements 41 and 42 (L1 in FIG. 3) is 5.7 mm.

FIG. 4 is a drawing to show frequency characteristics of the axial ratio in the maximum radiation direction of the circular polarized antenna 10. As seen in FIG. 4, the axial ratios are 3 dB or less between about 1220 MHz and about 1380 MHz in the maximum radiation direction. It is seen that the circular polarized antenna 10 has a very wideband characteristics as the fractional bandwidth where the axial ratios are 3 dB or less is about 12 percent. As the value indicated by dB is lower, it means that a circular polarized wave having a low axial ratio (close to a circle) is radiated. The fractional bandwidth is calculated by dividing the bandwidth by center frequency 1300 MHz.

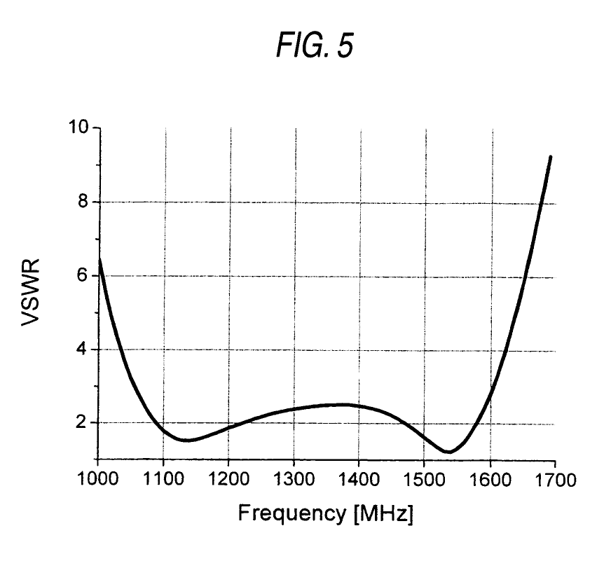

FIG. 5 is a drawing to show impedance frequency characteristics of the circular polarized antenna 10. The impedance refers to VSWR (Voltage Standing Wave Ratio).

As seen in FIG. 5, the VSWRs are 3 dB or less between about 1055 MHz and about 1605 MHz. That is, it is seen that the circular polarized antenna 10 has a very wideband characteristics as the fractional bandwidth where the VSWRs are 3 dB or less is 37 percent or more.

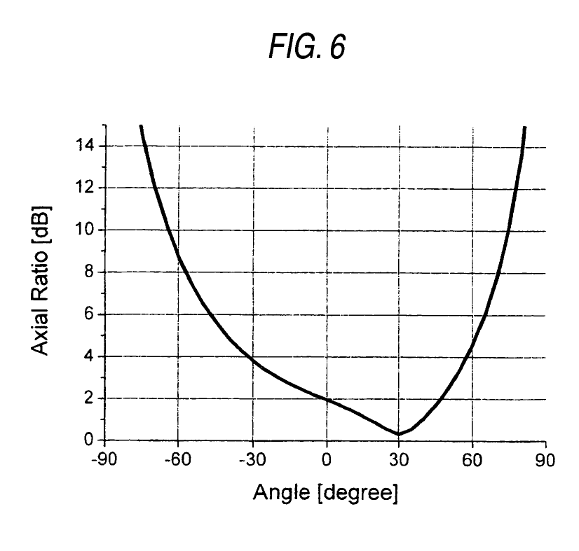

FIG. 6 is a graph to show pattern of the axial ratio to the elevation angle at the center frequency 1300 MHz of the circular polarized antenna 10. The elevation angle of 0 degrees indicates the direction perpendicular to the conductor ground plate 20 and the L-shaped monopole conductor elements 41 and 42.

As seen in FIG. 6, the axial ratios are 3 dB or less in a range from about −20 deg to about 53 deg. It is seen that the circular polarized antenna 10 has a wide-angle axial ratio characteristics as the axial ratios are 3 dB or less in a wide range of 60 degrees or more.

As described above, according to the first embodiment, the L-shaped monopole conductor elements 41 and 42 are arranged so that the open ends are arranged to be close to the two adjacent edges E1 and E2 of the square-shaped conductor ground plate 20 formed with the cutout 30, so that the fractional bandwidth can be improved in both the impedance characteristics and the axial ratio characteristics. Therefore, the circular polarized antenna 10 according to the embodiment can provide the impedance characteristics and the axial ratio characteristics good in a wide frequency band and can perform good communications.

Since the element length of each of the L-shaped monopole conductor elements 41 and 42 is a quarter wavelength of the resonance frequency, one side of the conductor ground plate 20 can be made a half-wavelength or less and the circular polarized antenna 10 can also be miniaturized. Further, the conductor ground plate 20 and the L-shaped monopole conductor elements 41 and 42 can be arranged on the same plane and the circular polarized antenna 10 can also be easily implemented on a dielectric board.

The connection points CPa and CPb of the L-shaped monopole conductor elements 41 and 42 and the conductor ground plate 20 are at the equal distance (distance L) from the apex A, but may be center points of the edges E1 and E2. In this case, the currents J1 and J2 flowing into the edges E1 and E2 between the connection points CPa and CPb and the apex A and currents J3 and J4 (not shown) flowing into the edges E1 and E2 except between the connection points CPa and CPb and the apex A become almost the same in magnitude (namely, J1 nearly equals to J3 and J2 nearly equals to J4). If the edges E1 and E2 have the same length, the magnitudes of the currents J1 and J2 become almost the same and therefore the magnitudes of the currents flowing into the orthogonal edges E1 and E2 become almost the same (J1+J3 nearly equals to J2+J4) and it is made possible to radiate a good circular polarized wave from the circular polarized antenna 10.

In FIG. 1, the shape of the cutout 30 made in the conductor ground plate 20 is a square, but edges of the cutout 30 in the cutout 30 nearest to the edges E1 and E2 (e1 and e2 in FIG. 1) may be parallel with the edges E1 and E2. The currents flowing into the conductor ground plate in the vicinity of the L-shaped monopole conductor elements 41 and 42 of radiation elements largely affect radiation of a circular polarized wave. The current flowing into the conductor ground plate strongly flows into edges. If the edges E1 and E2 of the cutout 30 close to the L-shaped monopole conductor elements 41 and 42 are made parallel with the edges E1 and E2 of the conductor ground plate 20, the edges (E1 and E2), (e1 and e2) of the conductor ground plate 20 in the vicinity of the L-shaped monopole conductor elements 41 and 42 are orthogonal to each other, so that the currents J1 and J2 flowing into the edges are also orthogonal and it becomes easy to radiate a circular polarized wave.

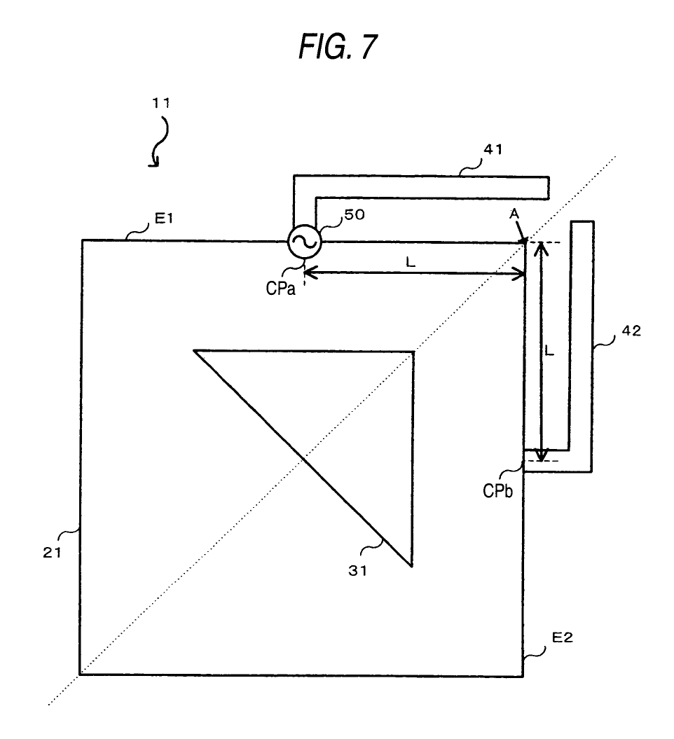

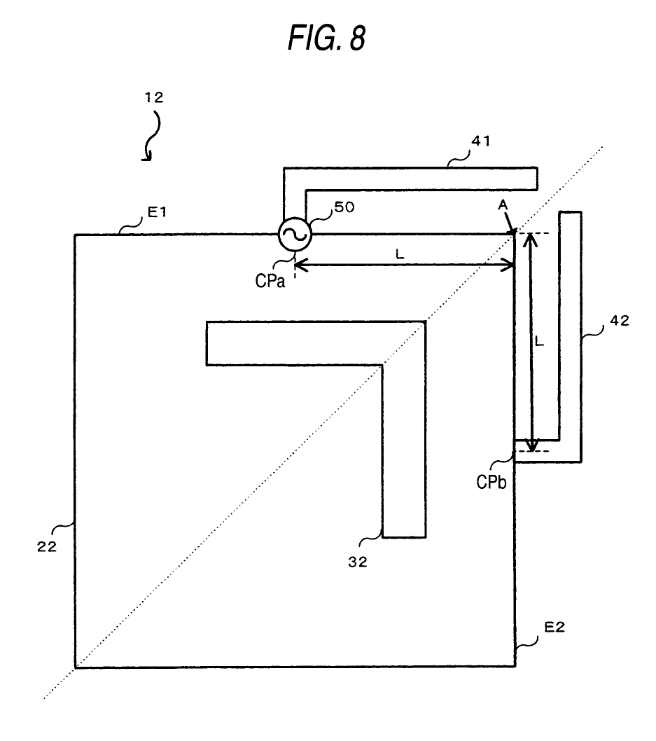

Therefore, the shape of a cutout 31 may be a triangle as shown in FIG. 7. A cutout 32 shaped as two cutouts each having a given width are connected at ends, namely, shaped like a letter L may be formed on a conductor ground plate 21, as shown in FIG. 8. However, the currents induced in the L-shaped monopole conductor elements 41 and 42 also flow into edges other than the edge E1 or E2 of the conductor ground plate 20. Therefore, if the square-shaped cutout 30 is formed on the conductor ground plate 20, combining of currents flowing into any other than the apex A can also be suppressed and thus a good axial ratio characteristics can be obtained as compared with the cutout 31 shaped like a triangle or the cutout 32 shaped like a letter L.

### FIRST MODIFIED EXAMPLE

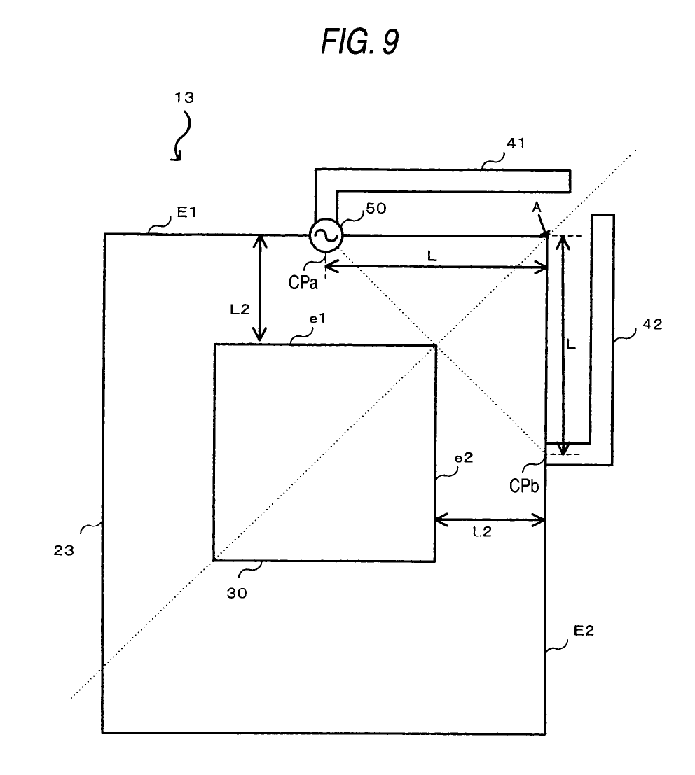

A first modified example of the circular polarized antenna 10 according to the embodiment is shown with FIG. 9. The conductor ground plate 20 of the circular polarized antenna 10 shown in FIG. 1 is a four-time rotation symmetrical shape. The expression “four-time rotation symmetrical shape” mentioned here is used to mean a shape matching the original shape if the pattern is rotated 90 degrees.

Since the circular polarized antenna 10 shown in FIG. 1 has the conductor ground plate 20 formed like a four-time rotation symmetrical shape, the magnitudes of the currents flowing into the conductor ground plate 20 easily become nearly equal and a good axial ratio characteristics in a wide band can be obtained. However, even if the shape of the conductor ground plate is not the four-time rotation symmetrical shape, unless it does not become largely asymmetrical, a good axial ratio characteristics in a wide band can be obtained according to a similar principle to that in FIG. 1. A conductor ground plate 23 may be a rectangle, for example, as shown in FIG. 9.

Particularly, in a circular polarized antenna 13 shown in FIG. 9, edges e1 and e2 of square-shaped cutout 30 parallel with edges E1 and E2 are at an equal distance L2 from the edges E1 and E2, and connection points CPa and CPb of L-shaped monopole conductor elements 41 and 42 and the edges E1 and E2 are arranged at points at an equal distance from an apex A. Therefore, a part of the circular polarized antenna 13 is symmetrical with respect to a line with a symmetry axis (a line passing through the apex A and roughly perpendicular to the line connecting the connection points CPa and CPb) as the center, so that a good axial ratio characteristics and a good impedance characteristics in a wide band can be obtained.

The shape of the cutout 30 and the connection points CPa and CPb of the circular polarized antenna 13 are not limited to those shown in FIG. 9 and may be any if the shape does not become largely asymmetrical as the shape of the conductor ground plate 23. For example, the cutout 30 may be shaped like a rectangle and the connection points CPa and CPb may be provided at the middle points of the edges E1 and E2.

As shown in the first modified example described above, the shape of the conductor ground plate 23 can be deformed unless it becomes largely asymmetrical, so that the circular polarized antenna 13 can be configured corresponding to the place where it is installed.

### Second Embodiment

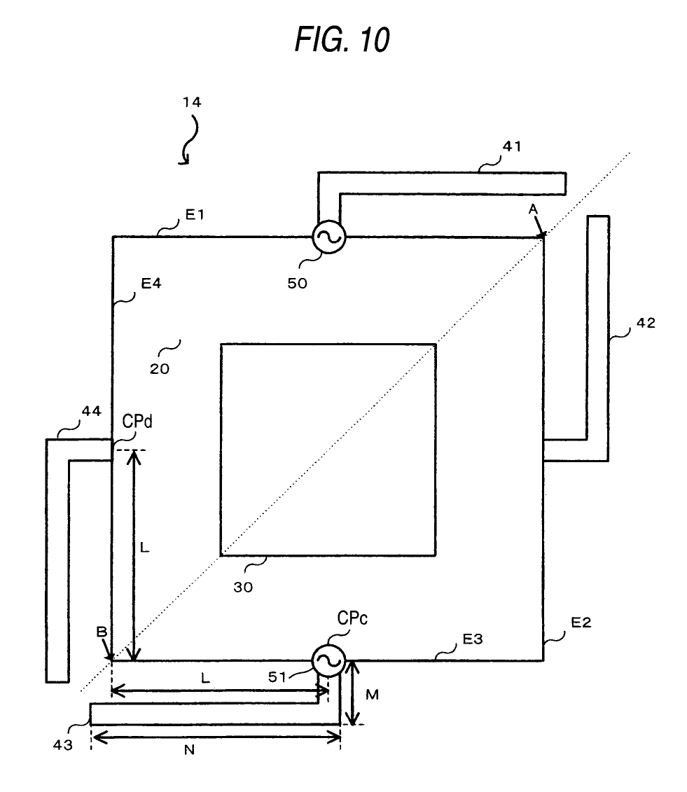

A circular polarized antenna 14 according to a second embodiment of the present invention will be described with FIG. 10. A configuration and the operation of the circular polarized antenna 14 shown in FIG. 10 are the same as those of the circular polarized antenna 10 shown in FIG. 1 excepting that the circular polarized antenna 14 further includes L-shaped monopole conductor elements 43 and 44. Components identical with those previously described with reference to FIG. 1 are denoted by the same reference numerals in FIG. 10 and will not be discussed again.

The L-shaped monopole conductor elements 43 and 44 are connected to edges E3 and E4 through connection points CPc and CPd at a distance L from an apex B of a conductor ground plate 20. The L-shaped monopole conductor element 43 extends a distance M perpendicularly to the side E3 from the connection point CPc and extends a distance N toward the apex B in parallel with the side E3. The L-shaped monopole conductor element 44 extends the distance M perpendicularly to the edge E4 from the connection point CPd and extends the distance N toward the apex B in parallel with the edge E4. A configuration and an operation principle of the L-shaped monopole conductor elements 43 and 44 are the same as those of L-shaped monopole conductor elements 41 and 42 excepting that the L-shaped monopole conductor elements 43 and 44 are arranged on the sides E3 and E4. Therefore, the circular polarized antenna 14 shown in FIG. 10 is symmetrical with respect to a line (symmetry axis).

The circular polarized antenna 14 shown in FIG. 10 uses the L-shaped monopole conductor elements 41 and 42 for transmission and the L-shaped monopole conductor elements 43 and 44 for reception, for example.

Generally, as the circular polarized antenna, a patch antenna element is used. Since the patch antenna element can be used only for either transmission or reception, for both transmission and reception, two patch antenna elements become necessary and the antenna became large in size.

However, in the circular polarized antenna 14 according to the embodiment, two pairs of L-shaped monopole conductor elements are connected to one conductor ground plate 20. Since the L-shaped monopole conductor elements 41 to 44 are small as compared with the patch antenna elements, the circular polarized antenna 14 capable of executing both transmission and reception can be configured without upsizing the circular polarized antenna 10.

As described above, according to the circular polarized antenna 14 shown in the second embodiment, similar advantages to those of the first embodiment can be provided and in addition, two pairs of L-shaped monopole conductor elements can be installed in one circular polarized antenna without upsizing the circular polarized antenna. Accordingly, the small circular polarized antenna 14 capable of executing both transmission and reception can be provided, for example.

In FIG. 10, a feed point 51 is provided at the connection point CPc of the L-shaped monopole conductor element 43 and the edge E3. In this case, a circular polarized wave radiated from the L-shaped monopole conductor elements 43 and 44 turns in the same direction as a circular polarized wave radiated from the L-shaped monopole conductor elements 41 and 42. If the feed point 51 is provided at the connection point CPd of the L-shaped monopole conductor element 44 and the edge E4, the turn direction of the circular polarized wave radiated from the L-shaped monopole conductor elements 43 and 44 becomes opposite to the turn direction of the circular polarized wave radiated from the L-shaped monopole conductor elements 41 and 42.

### SECOND MODIFIED EXAMPLE

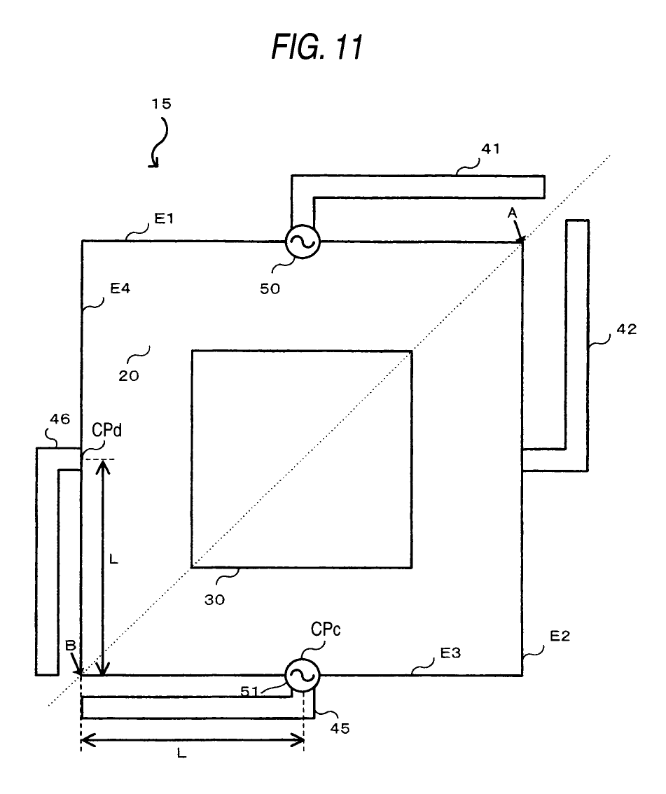

FIG. 11 shows a modified example of the circular polarized antenna according to the second embodiment of the present invention. A configuration and an operation of a circular polarized antenna 15 shown in FIG. 11 are the same as those of the circular polarized antenna 14 shown in FIG. 10 excepting that the element length of an L-shaped monopole conductor element 45, 46 differs from the element length of the L-shaped monopole conductor element 43, 44 shown in FIG. 10 (the former is shorter than the latter in the example in FIG. 11).

As shown in FIG. 11, two pairs of L-shaped monopole conductor elements are made different in the element length, so that the two pairs of L-shaped monopole conductor elements resonate at different frequencies. Therefore, it is made possible for the circular polarized antenna 15 to transmit and receive wireless signals at different frequencies.

### Third Embodiment

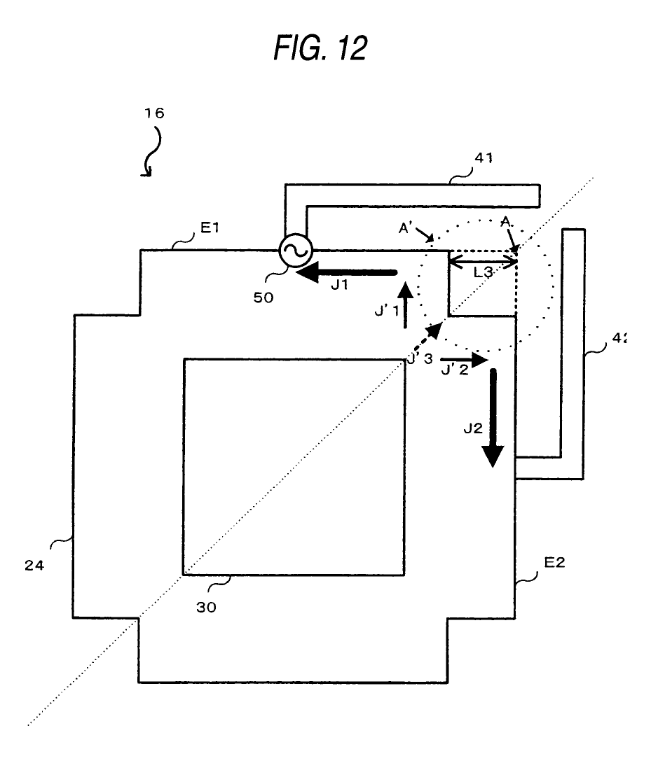

A circular polarized antenna 16 according to a third embodiment of the present invention will be described with FIGS. 12 to 16. A configuration and an operation of the circular polarized antenna 16 shown in FIG. 12 are the same as those of the circular polarized antenna 10 shown in FIG. 1 except for the shape of a conductor ground plate 24. Therefore, components identical with those previously described with reference to FIG. 1 are denoted by the same reference numerals in FIG. 12 and will not be discussed again.

The conductor ground plate 24 of the circular polarized antenna 16 is shaped like a cross with four corners of a square each cut away as a square whose one side is L3. A part of the conductor ground plate 24 containing the cut-away square is called corner A′. Since the conductor ground plate 24 is shaped like a cross, both the axial ratio characteristics and the impedance characteristics are improved as compared with the circular polarized antenna 10 shown in FIG. 1. The reason why the axial ratio characteristics and the impedance characteristics of the circular polarized antenna 16 are improved is as follows.

Currents J1 and J2 induced by L-shaped monopole conductor elements 41 and 42 flow into the conductor ground plate 24. If the conductor ground plate is formed in square shape, the currents J1 and J2 are combined at an apex A into a current J3 in a slanting direction causing the axial ratio characteristics to be degraded (see FIG. 3).

However, as shown in FIG. 12, if the conductor ground plate 24 is shaped like a cross, each edge of the corner A′ is distant from the tips of the L-shaped monopole conductor elements 41 and 42 as compared with the case where the conductor ground plate is formed in square shape. Generally, the current flowing into a conductor ground plate becomes larger as it is closer to a radiation element; smaller as it is more distant from a radiation element. Therefore, currents J′1 and J′2 flowing along the edges of the corner A′ become smaller than J1 and J2. The currents J′1 and J′2 are combined into a current J′3 in a slanting direction, but J′1<J1 and J′2<J2 and thus J′3<J3. Thus, the slanting current J′3 can be made smaller and the axial ratio characteristics can be more improved.

In the embodiment, the conductor ground plate is cut away as a square so that the sides of the corner A′ become roughly perpendicular to edges E1 and E2. However, the sides of the corner A′ may not become roughly perpendicular to the edges E1 and E2, for example, in such a manner that the four corners of a square-shaped conductor ground plate are cut away slantingly. Also in this case, the axial ratio characteristics can be improved for the reason described above. However, if the four corners of the conductor ground plate 24 are cut away slantingly, a current also flows into the cut-away edges. The current does not become perpendicular to the edge E1 or E2 and thus becomes a slanting current for degrading the axial ratio characteristics. Therefore, if the conductor ground plate 24 is shaped like a cross as shown in FIG. 12, the axial ratio characteristics can be most improved.

Next, the reason why the impedance characteristics are improved is as follows. If the conductor ground plate 24 is shaped like a cross, the edges of the corner A′ are distant from the tips of the L-shaped monopole conductor elements 41 and 42 as compared with the case where the conductor ground plate is formed in square shape. Stray capacitance occurs between the open ends of the L-shaped monopole conductor elements 41 and 42; stray capacitance also occurs between the L-shaped monopole conductor element 41, 42 and the conductor ground plate 24. The electric element length of the L-shaped monopole conductor elements 41 and 42 is determined by the stray capacitance value between the open ends of the L-shaped monopole conductor elements 41 and 42 and the stray capacitance value between the L-shaped monopole conductor element 41, 42 and the conductor ground plate 24.

The capacitance value of the stray capacitance between the L-shaped monopole conductor element 41, 42 and the conductor ground plate 24 varies depending on the distance between the open end of the L-shaped monopole conductor element 41, 42 and the conductor ground plate. The shorter the distance between the open end of the L-shaped monopole conductor element 41, 42 and the conductor ground plate, the larger is the capacitance value. Since the circular polarized antenna 16 has the conductor ground plate 24 shaped like a cross, the distance between the open end of the L-shaped monopole conductor element 41, 42 and the corner A′ of the conductor ground plate 24 becomes long as compared with the circular polarized antenna 10 shown in FIG. 1. Therefore, in the second operation state, the capacitance value of the stray capacitance occurring in the L-shaped monopole conductor element 41, 42 lessens as much as the distance between the open end of the L-shaped monopole conductor element 41, 42 and the corner A′ of the conductor ground plate 24 becomes longer. Thus, the electric element length of the L-shaped monopole conductor element 41, 42 becomes further short and the highest resonance frequency becomes further high. Thus, the impedance characteristics of the circular polarized antenna 16 are also improved.

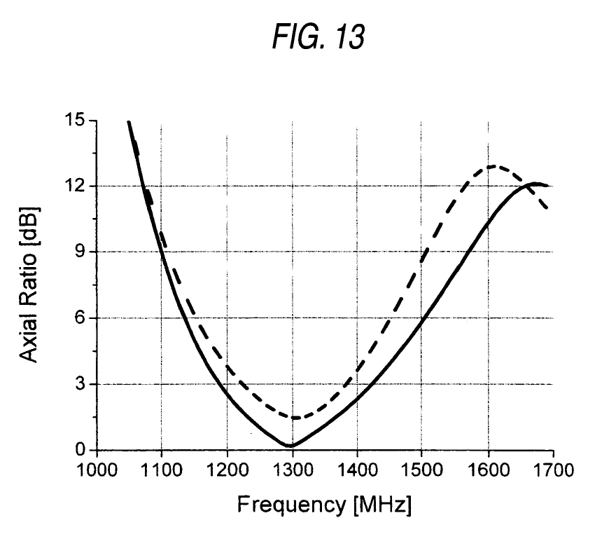

The result of simulation using the circular polarized antenna 16 will be described with FIGS. 13 to 15. The configuration of the circular polarized antenna 16 used for the simulation is shown below.

The conductor ground plate 24 is shaped like a cross provided by cutting away four corners of a square measuring 80 mm per side as the outline each as a square measuring L3=10 mm per side and has a cutout 30 measuring 40 mm per side in the center. The L-shaped monopole conductor element 41, 42 has the vertical portion being 10 mm long and the horizontal portion being 46 mm long, and the whole element length is 56 mm. The line distance between the open ends of the L-shaped monopole conductor elements 41 and 42 is 5.7 mm.

FIG. 13 is a drawing to show frequency characteristics of the axial ratio in the maximum radiation direction of the circular polarized antenna 16. As seen in FIG. 13, the axial ratios are 3 dB or less in a range from about 1190 MHz and to about 1420 MHz in the maximum radiation direction. It is seen that the circular polarized antenna 16 has a very wideband characteristics as the fractional bandwidth where the axial ratios are 3 dB or less is about 18 percent. As the value indicated by dB is lower, it means that a circular polarized wave having a low axial ratio (close to a circle) is radiated. The fractional bandwidth is calculated by dividing the bandwidth by the center frequency 1300 MHz.

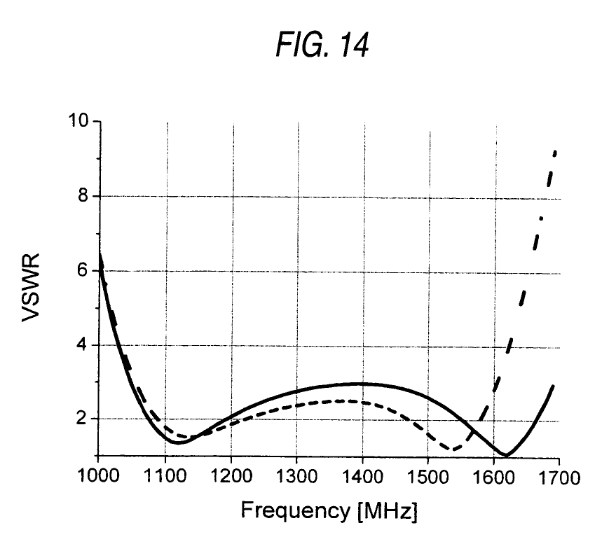

FIG. 14 is a drawing to show impedance frequency characteristics of the circular polarized antenna 16. The impedance refers to VSWR (Voltage Standing Wave Ratio).

As seen in FIG. 14, the VSWRs are 3 dB or less in a range from about 1050 MHz to about 1690 MHz. That is, it is seen that the circular polarized antenna 16 has a very wideband characteristics as the fractional bandwidth where the VSWRs are 3 dB or less is 39 percent or more.

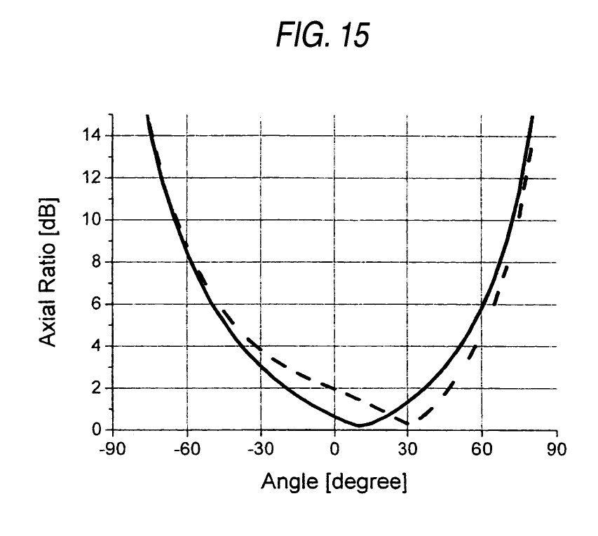

FIG. 15 is a graph to show pattern of the axial ratio to the elevation angle at the center frequency 1300 MHz of the circular polarized antenna 16. The elevation angle of 0 degrees indicates the direction perpendicular to the conductor ground plate 24 and the L-shaped monopole conductor elements 41 and 42.

As seen in FIG. 15, the axial ratios are 3 dB or less in a range from about −30 deg to about 45 deg. It is seen that the circular polarized antenna 16 has a wide-angle axial ratio characteristics as the axial ratios are 3 dB or less in a wide range of 60 degrees or more.

The dashed lines shown in FIGS. 13 to 15 indicate the simulation result of the circular polarized antenna 10 shown in FIG. 1 (see FIGS. 4 to 6).

As described above, according to the third embodiment, similar advantages to those of the first embodiment can be provided and in addition, the four corners of the conductor ground plate 24 are cut away each as a square, so that the distance between the corner A′ of the conductor ground plate 24 and the open end of the L-shaped monopole conductor element 41, 42 widens, the capacitance value of the stray capacitance occurring between the conductor ground plate 24 and the open end of the L-shaped monopole conductor element 41, 42 lessens, the fractional bandwidth in the impedance characteristics are improved, and a wider-band characteristics can be provided.

As the distance between the corner A′ of the conductor ground plate 24 and the open end of the L-shaped monopole conductor element 41, 42 widens, the amount of the current flowing into the corner A′ of the conductor ground plate 24 lessens and the current into which currents are combined at the corner A′, the current flowing into the edges of the conductor ground plate 24 slantingly can be suppressed, so that the fractional bandwidth in the axial ratio characteristics can be improved.

### Fourth Embodiment

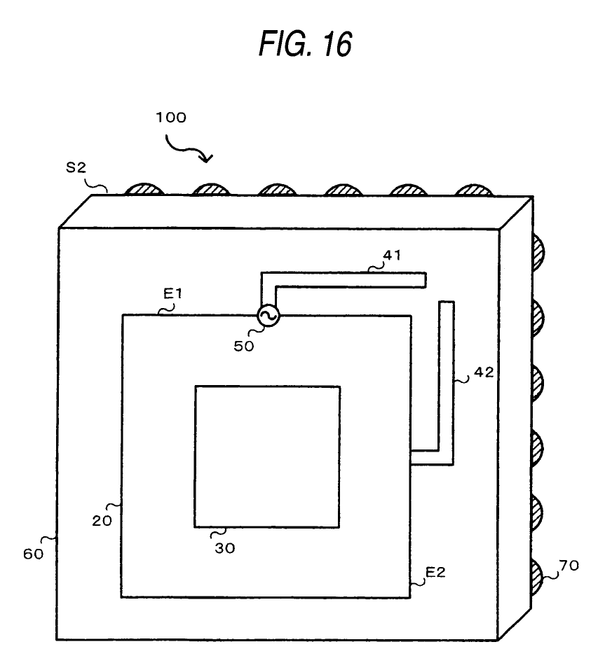

A semiconductor module according to a fourth embodiment of the present invention will be described with FIG. 16. FIG. 16 is a drawing to show an example of installing the circular polarized antenna 10 shown in FIG. 1 in a semiconductor module 100. A configuration and an operation of the circular polarized antenna 10 are the same as those shown in FIG. 1 and therefore components identical with those previously described with reference to FIG. 1 are denoted by the same reference numerals in FIG. 16 and will not be discussed again.

The semiconductor module 100 shown in FIG. 16 has a dielectric board 60, the circular polarized antenna 10 provided on a face S1 of the dielectric board 60, and a solder ball 70 provided on a face S2 opposed to the face S1 of the dielectric board 60. Thus, the circular polarized antenna 10 is provided on the dielectric board 60 and the solder ball 70 is provided below the dielectric board 60, whereby a module is provided.

As described above, according to the semiconductor module according to the fourth embodiment, similar advantages to those of the first embodiment can be provided and in addition, the circular polarized antenna 10 can be put into a module. Therefore, the circular polarized antenna 10 can be installed in one semiconductor module and a small semiconductor module having a wireless function can be realized.

The face S1 of the semiconductor module 100 shown in FIG. 16 may be sealed with a mold material (not shown). The circular polarized antenna 10 has a large metal portion. Therefore, the circular polarized antenna 10 is sealed with a mold material, so that the electric length of the metal portion can be shortened and the circular polarized antenna 10 can be miniaturized.

The circular polarized antenna 10 shown in FIG. 1 is installed in the semiconductor module 100, but the antenna shown in FIGS. 4 to 12 may be installed in the semiconductor module 100.

### Fifth Embodiment

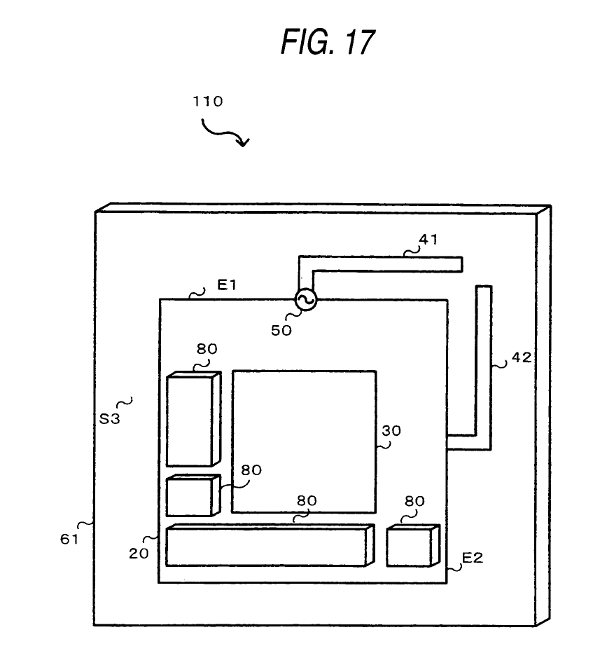

A wireless communication device 110 according to a fifth embodiment of the present invention will be described with FIG. 17. FIG. 17 is a drawing to show an example of installing the circular polarized antenna 10 shown in FIG. 1 in the wireless communication device 110. The configuration and the operation of the circular polarized antenna 10 are the same as those shown in FIG. 1 and therefore components identical with those previously described with reference to FIG. 1 are denoted by the same reference numerals in FIG. 17 and will not be discussed again.

The wireless communication device 110 shown in FIG. 17 includes a board 61, the circular polarized antenna 10 provided on a face S3 of the board 61, and wireless circuits 80 provided on the conductor ground plate 20 of the circular polarized antenna 10.

Each of the wireless circuits 80 is a circuit required for transmitting and receiving wireless signals, such as a circuits for generating wireless signals and transmitting the generated wireless signals through the circular polarized antenna 10, for example, modulation circuits, etc., or circuits for demodulating wireless signals received through the circular polarized antenna 10 into data, for example, demodulation circuits, etc.

As described above, according to the fifth embodiment, similar advantages to those of the first embodiment can be provided and in addition, the wireless circuits 80 is placed on the conductor ground plate 20 of the circular polarized antenna 10, so that the wireless circuits 80 can be arranged in the proximity of the circular polarized antenna 10 and degradation of the wireless signals caused by routing of line can be suppressed.

The circular polarized antenna 10 shown in FIG. 1 is installed in the wireless communication device 110, but the antenna shown in FIGS. 4 to 12 may be installed in the wireless communication device 110.

### Sixth Embodiment

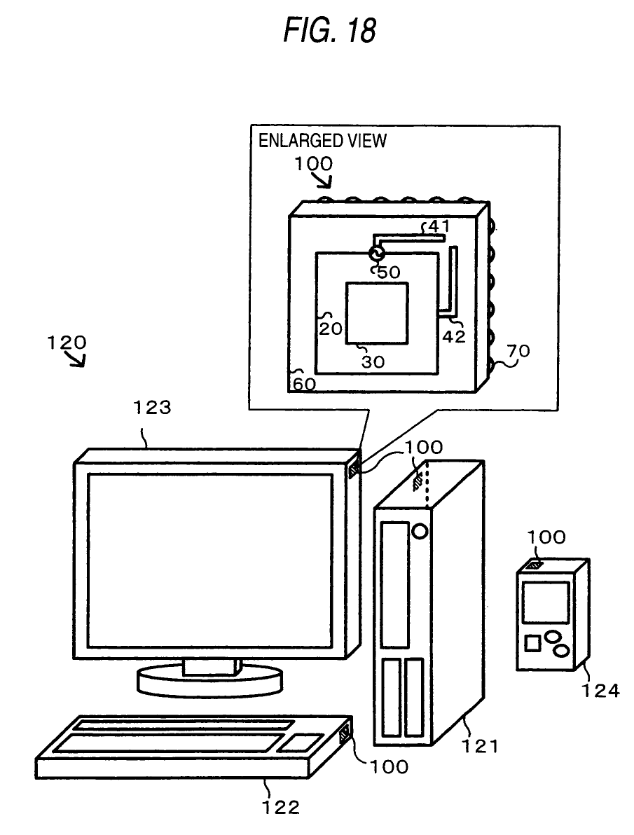

A wireless system 120 according to a sixth embodiment of the present invention will be described with FIG. 18. FIG. 18 is a drawing to show an example of the wireless system 120 made up of wireless communication devices each installing the semiconductor module 100 shown in FIG. 16.

The wireless system 120 includes a data processing apparatus 121, an input unit 122 for transmitting user-entered information to the data processing apparatus 121, a display 123 for displaying information processed by the data processing apparatus 121, and a mobile terminal 124 for communicating with the data processing apparatus 121. The semiconductor module 100 shown in FIG. 16 is installed in every component of the system for the system components to communicate with each other using wireless signals in millimeter-wave band, for example, through the circular polarized antenna 10.

FIG. 18 shows an example in which the wireless system 120 includes a personal computer, a mobile terminal such as a PDA, and the like. In this case, the data processing apparatus 121 corresponds to a personal computer main unit, the input unit 122 corresponds to a keyboard, the display 123 corresponds to a display, and the mobile terminal 124 corresponds to a PDA, a mobile music player, etc.

An operation example of the wireless system 120 according to the embodiment will be described. Here, processing for the data processing apparatus 121 to transmit data stored therein to the mobile terminal 124 according to a command from the user will be described.

The data processing apparatus 121 generates display data for inquiring of the user whether or not data is to be transmitted to the mobile terminal 124, and transmits the display data to the display 123 through the circular polarized antenna 10. The display 123 receives the display data through the circular polarized antenna 10 and displays the display data for the user. The user views the display data and enters an answer as to whether or not retained data is to be transmitted to the mobile terminal 124 through the input unit 122. To refuse to transmit data, the user terminates the processing. The case where the user permits transmitting data will be described below.

The input unit 122 transmits user-entered information to the data processing apparatus 121 through the circular polarized antenna 10. The data processing apparatus 121 processes the entered information received through the circular polarized antenna 10 and transmits the retained data to the mobile terminal 124. The retained data is also transmitted through the circular polarized antenna 10.

The processing has been described by way of example and the components can transfer data to and from each other through the circular polarized antenna 10 as shown in the embodiment if the data is transferred through a wireless line. The components of the wireless system 120 are not limited to those shown in FIG. 18 and may be various devices, units, and apparatus such as an output unit of a printer, etc., and an input unit of a touch panel, etc.

As described above, according to the sixth embodiment, the small semiconductor module 100 is installed in each component, so that various components can be easily provided with a wireless function and wiring of connecting the components can be omitted. Since the circular polarized antenna 10 shown in FIG. 1 is installed in the semiconductor module 100, it is made possible to perform good wireless communications in a wide band, and large-capacity and high-speed wireless communication can be realized.

### Seventh Embodiment

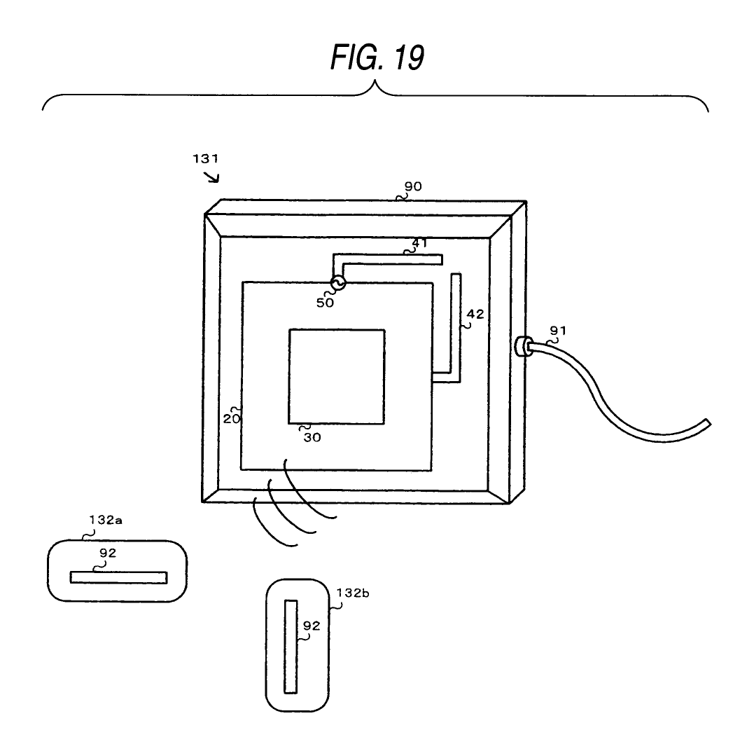

An RFID system 130 according to a seventh embodiment of the present invention will be described with FIG. 19. FIG. 19 is a drawing to show an example of the RFID system 130 according to the embodiment of the present invention.

The RFID system 130 includes a reader/writer 131 in which the circular polarized antenna 10 shown in FIG. 1 is installed and a plurality of RFID tags 132a for communicating with the reader/writer 131. Hereinafter, the plurality of RFID tags 132a will be collectively called RFID tag 132.

The reader/writer 131 has a cabinet 90 and the circular polarized antenna 10 placed in the cabinet 90 and is connected to a wireless communication device (not shown) by a feeder line 91. The reader/writer 131 radiates a wireless signal input via the feeder line 91 from the circular polarized antenna 10 and receives wireless signals from the RFID tag 132 through the circular polarized antenna 10 and outputs the wireless signal to the wireless communication device.

The RFID tag 132 has a linear antenna 92 and a wireless communication circuit (not shown).

When the reader/writer uses a linearly polarized wave antenna, transmission and reception may become impossible depending on the orientation of the RFID tag 132.

In the example shown in FIG. 19, the RFID tag 132a can well transmit and receive a wireless signal of a horizontally polarized wave, but is hard to well transmit and receive a wireless signal of a vertically polarized wave. On the other hand, RFID tag 132b can well transmit and receive a wireless signal of a vertically polarized wave, but is hard to well transmit and receive a wireless signal of a horizontally polarized wave.

However, the reader/writer 131 shown in FIG. 19 installs the circular polarized antenna 10 shown in FIG. 1 and can well transmit and receive a wireless signal of a circular polarized wave in a wide frequency-band and in a wide angle. Therefore, communications can be conducted regardless of the orientation of the RFID tag 132 and both the RFID tags 132a and 132b can perform good wireless communications with the reader/writer 131.

As described above, according to the seventh embodiment, the circular polarized antenna 10 shown in FIG. 1 is installed in the reader/writer 131 of the RFID system 130, so that good wireless communications can be accomplished between the RFID tag 132 and the reader/writer 131 regardless of the type of antenna installed in the RFID tag 132 or the orientation of the RFID tag 132.

It is to be understood that the invention is not limited to the specific embodiment described above and that the present invention can be embodied with the components modified without departing from the spirit and scope of the present invention. The present invention can be embodied in various forms according to appropriate combinations of the components disclosed in the embodiments described above. For example, some components may be deleted from all components shown in the embodiments. Further, the components in different embodiments may be used appropriately in combination.

What is claimed is:

1. A circular polarized antenna comprising:
a conductor ground plate that is formed with an opening;
first and second monopole conductor elements that are formed in L-shape having substantially the same length, the first and second monopole conductor elements being respectively connected to the conductor ground plate at first and second connection points; and
a feed point provided at one of the first and second connection points,
wherein the first and second monopole conductor elements are arranged to be substantially orthogonal to each other, and open ends of the respective first and second monopole conductor elements are arranged to be adjacent to each other,
wherein a first part and a second part of the antenna are configured to be symmetrical with respect to a straight line passing between the open ends of the first and second monopole conductor elements, the straight line being substantially perpendicular to a line connecting the first and second connection points,
wherein the first part includes: (1) a first half of the conductor ground plate formed on one side of the straight line including the first monopole conductor element; and (2) the first monopole conductor element, and
wherein the second part includes: (3) a second half of the conductor ground plate formed on the other side of the straight line including the second monopole conductor element; and (4) the second monopole conductor element.

2. The antenna according to claim 1, wherein the first connection point is provided on a first edge included in the first half of the conductor ground plate and the second connection point is provided on a second edge included in the second half of the conductor ground plate, the first and second edges being arranged to be substantially perpendicular to each other,
wherein the opening formed on the conductor ground plate has: [A] a first nearest edge that is nearest to the first edge of the conductor ground plate; and [B] a second nearest edge that is nearest to the second edge of the conductor ground plate, and
wherein the first and second nearest edges of the opening are respectively arranged to be in parallel to the first and second edges of the conductor ground plate.

3. The antenna according to claim 2, wherein the first connection point is provided at substantially center of the first edge, and
wherein the second connection point is provided at substantially center of the second edge.

4. The antenna according to claim 3, wherein the conductor ground plate and the opening are formed in square shape.

5. The antenna according to claim 2, wherein the conductor ground plate has a corner being cut away in a square shape at an intersection point of the first and second edges.

6. The antenna according to claim 4, wherein the conductor ground plate has all four corners being cut away in a square shape to be in a cross shape.

7. The antenna according to claim 1 further comprising:
third and forth monopole conductor elements that have substantially the same length and are respectively connected to the conductor ground plate at third and forth connection points, the third and fourth monopole conductor elements being arranged at positions opposite the first and second conductor elements with respect to a center of the conductor ground plate; and
a second feed point provided at one of the third and fourth connection points.

8. The antenna according to claim 1, wherein the conductor ground plate and the first and second monopole conductor elements are formed on a same plane.

9. The antenna according to claim 1, wherein the first and second monopole conductor elements have a length of substantially a quarter wavelength of an operating frequency of the antenna.

10. A circular polarized antenna comprising:
a conductor ground plate with an opening and including a first plate and a second plate being symmetrical with respect to a straight line passing a center of the opening, the first plate having a first connection point and the second plate having a second connection point, a line connecting the first and second connection points being substantially perpendicular to the straight line;
first and second monopole conductor elements that are formed in L-shape having substantially the same length and being disposed symmetrically with respect to the straight line, the first monopole conductor element being connected to the first plate at the first connection point and the second monopole conductor element being connected to the second plate at the second connection point; and
a feed point provided at one of the first and second connection points,
wherein the first and second monopole conductor elements are arranged to be substantially orthogonal to each other, and open ends of the respective first and second monopole conductor elements are arranged to be adjacent to each other.

11. A semiconductor module comprising:
a dielectric substrate; and
the antenna according to claim 1 being placed on the dielectric substrate.

12. A wireless communication device comprising:
the antenna according to claim 1; and
a wireless communication circuit that is placed on the conductor ground plate of the antenna.
